(19) United States
(12) Patent Application Publication
(10) Pub. No.: US 2026/0079833 A1
(43) Pub. Date: Mar. 19, 2026

(54) MEMORY SYSTEM AND CONTROL METHOD

(71) Applicant: Kioxia Corporation, Tokyo (JP)

(72) Inventor: Shoichi YOKOBORI, Kamakura (JP)

(73) Assignee: Kioxia Corporation, Tokyo (JP)

(21) Appl. No.: 19/077,862

(22) Filed: Mar. 12, 2025

(30) Foreign Application Priority Data
Sep. 19, 2024 (JP) 2024-161963

(51) Int. Cl. G06F 12/02

(52) U.S. Cl. CPC G06F 12/0246

(57) ABSTRACT

A memory system includes: a first nonvolatile memory; a first memory controller operatively coupled to the first nonvolatile memory through a first interface and to a host device; and a connection portion to which a memory card is connectable, wherein the memory card includes a second nonvolatile memory and a second memory controller configured to control the second nonvolatile memory. When the memory card is connected to the memory system, the first memory controller is configured to acquire an identifier of the second nonvolatile memory from the memory card, and in response to a write request from the host device, when an identifier of the first nonvolatile memory and the acquired identifier of the second nonvolatile memory match with each other, the first memory controller is configured to write data designated by the write request into the first nonvolatile memory and the second nonvolatile memory.

### CROSS-REFERENCE TO RELATED APPLICATION

This application is based upon and claims the benefit of priority from Japanese Patent Application No. 2024-161963, filed Sep. 19, 2024, the entire contents of which are incorporated herein by reference.

### FIELD

Embodiments described herein relate generally to a memory system and a control method.

### BACKGROUND

In the related art, there is a host device such as a camera on which a plurality of slots housing a plurality of (for example, two) SD cards are mounted. For example, in a camera on which two slots are mounted, an acquired image is recorded in nonvolatile memories of the two SD cards in parallel, respectively. This use is to backup the acquired image.

On the other hand, a camera on which one slot is mounted can house only one SD card. Therefore, an acquired image cannot be recorded in nonvolatile memories of SD cards in parallel, respectively. In addition, in the related art, there is an SD card adapter that can house another SD card.

### DESCRIPTION OF THE DRAWINGS

FIG. 1 is a schematic diagram illustrating a schematic configuration of a memory system according to a first embodiment.

FIG. 2 is a schematic diagram illustrating a form where the memory system according to the first embodiment is connected to a memory card.

FIG. 3 is a schematic diagram illustrating the form where the memory system according to the first embodiment is connected to the memory card.

FIG. 4 is a schematic diagram illustrating a logical-to-physical address conversion table according to the first embodiment.

FIG. 5 is a schematic diagram illustrating a schematic configuration of the memory system according to the first embodiment.

FIG. 6 is a schematic diagram illustrating a schematic configuration of a host device and the memory card according to the first embodiment.

FIG. 7 is a flowchart illustrating an operation of the memory system according to the first embodiment.

FIG. 8 is a flowchart illustrating the operation of the memory system according to the first embodiment.

FIG. 9 is a flowchart illustrating the operation of the memory system according to the first embodiment.

FIG. 10 is a flowchart illustrating the operation of the memory system according to the first embodiment.

FIG. 11 is a flowchart illustrating an operation of the memory card according to the first embodiment.

FIG. 12 is a schematic diagram illustrating a schematic configuration of a memory system according to a first modification example.

FIG. 13 is a schematic diagram illustrating a schematic configuration of a memory system according to a second embodiment.

FIG. 14 is a flowchart illustrating an operation of the memory system according to the second embodiment.

FIG. 15 is a flowchart illustrating the operation of the memory system according to the second embodiment.

FIG. 16 is a flowchart illustrating an operation of a memory system according to a second modification example.

FIG. 17 is a schematic diagram illustrating a schematic configuration of a memory system according to a third modification example.

FIG. 18 is a schematic diagram illustrating a schematic configuration of a memory system according to a fourth modification example.

FIG. 19 is a flowchart illustrating an operation of a memory system according to a fifth modification example.

### DETAILED DESCRIPTION

Embodiments provide a memory system and a control method in which a memory card that can house another memory card is recognized as one memory card and can record an acquired image in two nonvolatile memories in parallel.

In general, according to one embodiment, a memory system includes: a first nonvolatile memory; a first memory controller operatively coupled to the first nonvolatile memory through a first interface and to a host device; and a connection portion to which a memory card is connectable, wherein the memory card includes a second nonvolatile memory and a second memory controller configured to control the second nonvolatile memory. When the memory card is connected to the memory system, the first memory controller is configured to acquire an identifier of the second nonvolatile memory from the memory card, and in response to a write request from the host device, when an identifier of the first nonvolatile memory and the acquired identifier of the second nonvolatile memory match with each other, the first memory controller is configured to write data designated by the write request into the first nonvolatile memory and the second nonvolatile memory.

Hereinafter, a memory system and a control method according to an embodiment will be described in detail with reference to the accompanying drawings. The disclosure is not limited to the following embodiment.

### First Embodiment

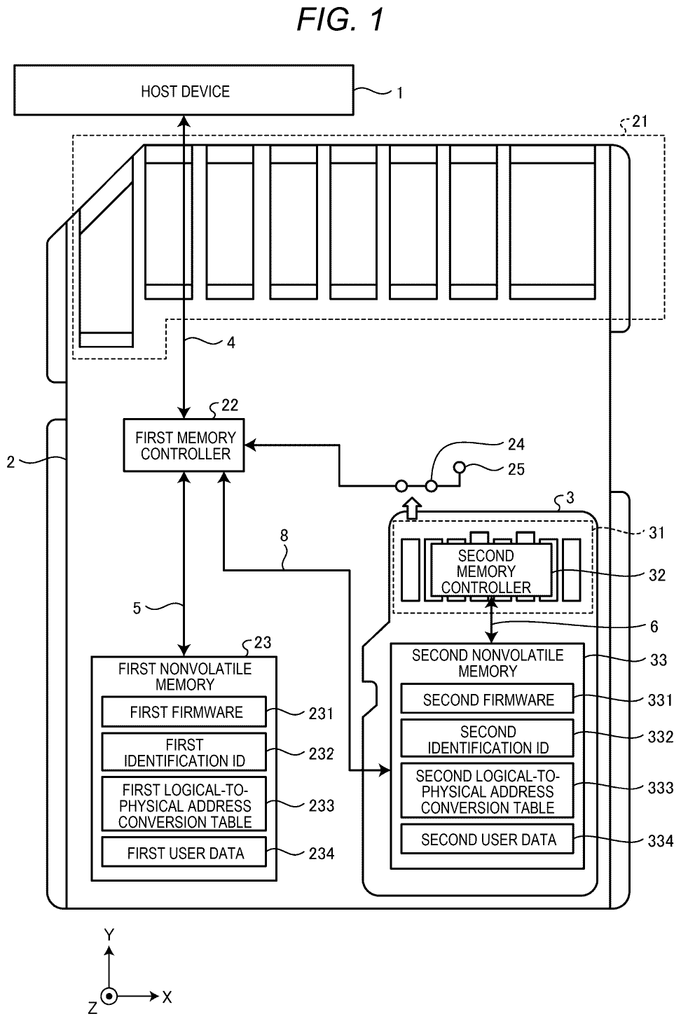

First, a memory system according to a first embodiment will be described in detail with reference to the drawings. FIG. 1 is a schematic diagram illustrating a schematic configuration of the memory system according to the first embodiment. As illustrated in FIG. 1, a memory system 2 includes a plurality of first terminals 21, a first memory controller 22, and a first nonvolatile memory 23. The memory system 2 is a memory card or the like where the plurality of first terminals 21, the first memory controller 22, and the first nonvolatile memory 23 are configured as one package. The memory system 2 is, for example, an SD card. The plurality of first terminals 21 are terminals according to SD standards.

The first memory controller 22 is a controller that is connectable to a host device 1, and communicates with the host device 1 through the plurality of first terminals 21 according to SD standards. The host device 1 may be, for example, an electronic apparatus such as a personal computer or a mobile terminal. The first memory controller 22 communicates with the host device 1, for example, through an SD interface 4. In addition, the first memory controller 22 controls the first nonvolatile memory 23 through a first interface 5. The first interface 5 is, for example, a NAND interface.

The first nonvolatile memory 23 is a nonvolatile memory that stores data in a nonvolatile manner, for example, a NAND flash memory (hereinafter, simply referred to as a NAND memory).

In addition, the memory system 2 is connectable to a memory card 3, and includes a slot that can house the memory card 3. The memory system 2 includes the memory card 3. For example, the memory system 2 is connected to the memory card 3 when the memory card 3 is housed in the slot. The slot is an example of a housing portion or a connection portion. FIG. 1 illustrates a state where the memory card 3 is housed in the memory system 2. For example, when the memory card 3 is housed, the memory system 2 controls a second nonvolatile memory 33 in the memory card 3 through a second interface 8.

The memory card 3 is a memory card or the like where a plurality of second terminals 31, a second memory controller 32, and the second nonvolatile memory 33 are configured as one package. The memory card 3 is an SD card having a different shape from the memory system 2, for example, a micro SD card. In addition, for example, the first nonvolatile memory 23 and the second nonvolatile memory 33 have the same storage capacity.

The plurality of second terminals 31 are terminals according to SD standards. The second memory controller 32 is a controller that is connectable to the host device 1, and is configured to communicate with the host device 1 through the plurality of second terminals 31 according to SD standards. The second memory controller 32 controls the second nonvolatile memory 33 through an interface 6, and the interface 6 is, for example, a NAND interface. The second nonvolatile memory 33 is a nonvolatile memory that stores data in a nonvolatile manner, for example, a NAND flash memory.

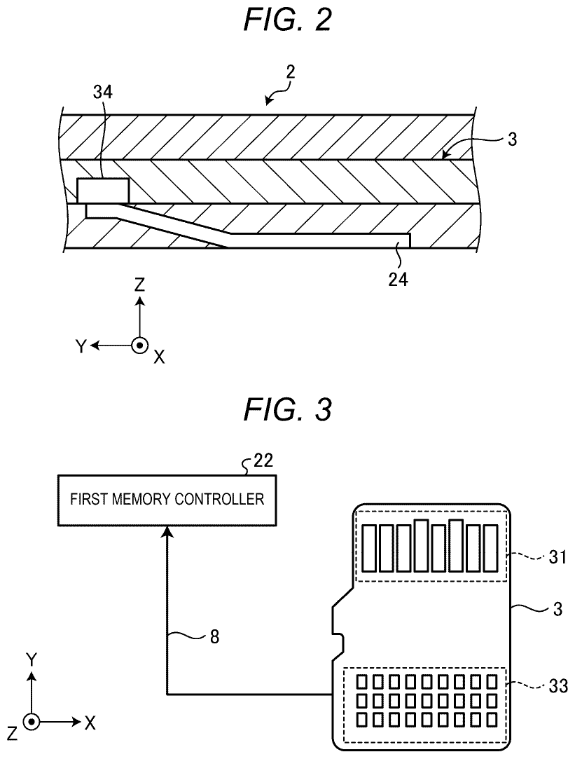

Here, a form where the memory system 2 is connected to the memory card 3 will be described using FIGS. 2 and 3. FIGS. 2 and 3 are schematic diagrams illustrating the form where the memory system 2 according to the first embodiment is connected to the memory card 3.

For example, as illustrated in FIG. 2, the memory system 2 includes a terminal 24, and the memory card 3 includes a terminal 34. The terminal 24 is a terminal for connection to the memory card 3. The terminal 34 is a terminal for connection to the memory system 2. The terminal 34 is, for example, a terminal of a NAND interface. For example, when a user houses the memory card 3 in the slot of the memory system 2, as illustrated in FIG. 2, the terminal 24 of the memory system 2 and the terminal 34 of the memory card 3 are connected.

FIG. 3 illustrates the first memory controller 22 in the memory system 2 and the memory card 3. When the connection of the memory card 3 is detected, the first memory controller 22 is connected to the second nonvolatile memory 33 in the memory card 3 through the second interface 8. The second interface 8 is, for example, a NAND interface.

Next, an example of signals transmitted and received between the first memory controller 22 and the first nonvolatile memory 23 will be described. For example, the first memory controller 22 transmits and receives signals to and from the first nonvolatile memory 23 through the first interface 5, the signals including a chip enable signal CEZ, a command latch enable signal CLE, an address latch enable signal ALE, a write enable signal WEZ, a read enable signal RE/REZ, data strobe signals DQS/DQSZ, a ready/busy signal RB, and an input/output signal I/O. Likewise, the first memory controller 22 transmits and receives the signals to and from the second nonvolatile memory 33 through the second interface 8.

That is, for example, the first memory controller 22 transmits and receives signals to and from the second nonvolatile memory 33, the signals including the chip enable signal CEZ, the command latch enable signal CLE, the address latch enable signal ALE, the write enable signal WEZ, the read enable signal RE/REZ, the data strobe signals DQS/DQSZ, the ready/busy signal RB, and the input/output signal I/O.

The chip enable signal CEZ is a signal for enabling the second nonvolatile memory 33. The command latch enable signal CLE and the address latch enable signal ALE are signals for notifying the second nonvolatile memory 33 that the input signals I/O to the second nonvolatile memory 33 are a command and an address, respectively.

The write enable signal WEZ is a signal for taking the input signal I/O into the second nonvolatile memory 33. The read enable signal RE/REZ is a signal for reading the output signal I/O from the second nonvolatile memory 33. The data strobe signals DQS/DQSZ are signals for instructing to take data transmitted and received along with the input/output signal I/O into the second nonvolatile memory 33.

The ready/busy signal RB is a signal representing whether the second nonvolatile memory 33 is in a ready state or a busy state. The ready state is a state where the second nonvolatile memory 33 can receive a command from the first memory controller 22. The busy state is a state where the second nonvolatile memory cannot receive a command from the first memory controller 22.

The input/output signal I/O is, for example, an 8-bit signal. The input/output signal I/O is the data that is transmitted and received between the second nonvolatile memory 33 and the first memory controller 22. The input/output signal I/O includes a command, an address, a status, write data, and read data. As a result, the memory system 2 can read and write data from and into the second nonvolatile memory 33.

Referring to FIG. 1 again, the description will be continued. The first nonvolatile memory 23 stores first firmware 231, a first identification ID 232, a first logical-to-physical address conversion table 233, and first user data 234. The second nonvolatile memory 33 stores second firmware 331, a second identification ID 332, a second logical-to-physical address conversion table 333, and second user data 334.

The first firmware 231 is a program for implementing an overall control of the first memory controller 22. The first memory controller 22 implements the overall control of the first memory controller 22, for example, by copying the first firmware 231 into a random access memory (RAM; not illustrated) and allowing a central processing unit (CPU) built in the first memory controller 22 to execute the first firmware 231. Control modes of the first memory controller 22 include a mode in which the memory system 2 starts in a read&write mode and a mode in which the memory system 2 starts in a read mode.

The second firmware 331 is a program for implementing an overall control of the second memory controller 32. The second memory controller 32 implements the overall control of the second memory controller 32, for example, by copying the second firmware 331 into a RAM (not illustrated) and allowing a CPU built in the second memory controller 32 to execute the second firmware 331. Control modes of the second memory controller 32 include a mode in which the memory card 3 starts in a read mode.

For example, during manufacturing of the memory system 2, in a state where the memory card 3 is housed in the memory system 2, the host device 1 performs a write process of writing the first identification ID 232 that is an identifier of the memory system 2 into the first nonvolatile memory 23. In addition, the host device 1 performs a write process of writing the second identification ID 332 that is an identifier of the memory card 3 into the second nonvolatile memory 33. The first identification ID 232 and the second identification ID 332 are unique identifiers for associating the first nonvolatile memory 23 and the second nonvolatile memory 33 with each other, which are the same identifier. The first identification ID 232 is written in the first nonvolatile memory 23, the second identification ID 332 is written in the second nonvolatile memory 33, and subsequently the memory system 2 is shipped.

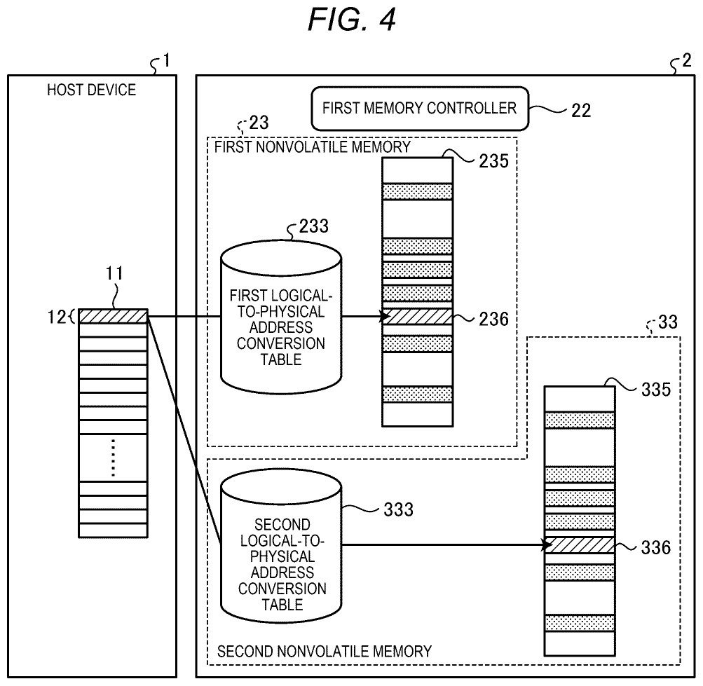

The first logical-to-physical address conversion table 233 and the second logical-to-physical address conversion table 333 associate logical addresses and physical addresses with each other. Here, the first logical-to-physical address conversion table 233 and the second logical-to-physical address conversion table 333 will be described using FIG. 4. FIG. 4 is a schematic diagram illustrating the logical-to-physical address conversion table according to the first embodiment. FIG. 4 illustrates a logical address 11 of the host device 1 (an address of a space that is virtually used by the host device 1), the first logical-to-physical address conversion table 233, a physical address 235 of the first nonvolatile memory 23, the second logical-to-physical address conversion table 333, and a physical address 335 of the second nonvolatile memory 33.

The logical address 11 is an address designated by the host device 1. The physical address 235 is an address designated by the first memory controller 22, and is an address representing a storage location of the first nonvolatile memory 23. The physical address 335 is an address designated by the first memory controller 22, and is an address representing a storage location of the second nonvolatile memory 33. A predetermined logical address 12 in the logical address 11 is associated with a predetermined physical address 236 in the physical address 235 and a predetermined physical address 336 in the physical address 335.

For example, when data is requested to be written, the host device 1 transmits, to the first memory controller 22, a write request including a write command, the predetermined logical address 12 in the logical address 11 (data logical address to be written), and data to be written. The first memory controller 22 converts the predetermined logical address 12 in the received write request into the predetermined physical address 236 in the physical address 235 with reference to the first logical-to-physical address conversion table 233, and accesses the first nonvolatile memory 23 based on the converted predetermined physical address 236 to write the data to be written (data designated by the write request) in the write request.

In addition, the first memory controller 22 converts the predetermined logical address 12 in the received write request into the predetermined physical address 336 in the physical address 335 with reference to the second logical-to-physical address conversion table 333, and accesses the second nonvolatile memory 33 based on the designated predetermined physical address 336 to write the data to be written in the write request.

For example, when data is requested to be read, the host device 1 transmits a read request including a read command and the predetermined logical address 12 to the first memory controller 22. The first memory controller 22 converts the predetermined logical address 12 in the received read request into the predetermined physical address 236 in the physical address 235 with reference to the first logical-to-physical address conversion table 233, and accesses the first nonvolatile memory 23 based on the converted predetermined physical address 236 to read data.

In addition, the first memory controller 22 may convert the predetermined logical address 12 in the received read request into the predetermined physical address 336 in the physical address 335 with reference to the second logical-to-physical address conversion table 333, and may access the second nonvolatile memory 33 based on the converted predetermined physical address 336 to read data.

Referring to FIG. 1 again, the description will be continued. The first user data 234 is data where data based on the data designated by the write request from the host device 1 is written into the first nonvolatile memory 23 by the first memory controller 22. The second user data 334 is data where data based on the data designated by the write request from the host device 1 is written into the second nonvolatile memory 33 by the first memory controller 22. The first user data 234 and the second user data 334 are data designated by the write request from the host device 1, and thus have the same data information. Hereinafter, first user data 234 and the second user data 334 will also be simply referred to as the data.

Next, a process that is executed by the first memory controller 22 will be described. For example, a start process of the memory system 2 when the memory system 2 where the memory card 3 is housed is connected to the host device 1 by the user will be described.

First, when the memory system 2 is recognized in the host device 1, a power supply 25 of the first memory controller 22 enters into an ON state. The first memory controller 22 detects the connection of the memory card 3. The first memory controller 22 determines whether the memory card 3 is present.

Here, when the first memory controller 22 detects the connection of the memory card 3 and determines that the memory card 3 is present, the first memory controller 22 reads the first identification ID 232 stored in the first nonvolatile memory 23 and the second identification ID 332 stored in the second nonvolatile memory 33.

For example, when the memory card 3 is housed in the slot, the first memory controller 22 is connected to the first nonvolatile memory 23 through the first interface 5, and reads the first identification ID 232 from the first nonvolatile memory 23 through the first interface 5 to acquire the first identification ID 232. When the read instruction of the first identification ID 232 is received from the first memory controller 22 through the first interface 5, the first nonvolatile memory 23 outputs the first identification ID 232 to the first memory controller 22.

In addition, when the memory card 3 is housed in the slot, the first memory controller 22 is connected to the second nonvolatile memory 33 through the second interface 8, and reads the second identification ID 332 from the second nonvolatile memory 33 through the second interface 8 to acquire the second identification ID 332. When the read instruction of the second identification ID 332 is received from the first memory controller 22 through the second interface 8, the second nonvolatile memory 33 outputs the second identification ID 332 to the first memory controller 22.

The first memory controller 22 determines whether the first identification ID 232 and the second identification ID 332 that are acquired match with each other. Here, when the first memory controller determines 22 that the first identification ID 232 and the second identification ID 332 that are acquired match with each other, the first memory controller 22 reads the first firmware 231 stored in the first nonvolatile memory 23.

Next, the first memory controller 22 executes an initialization process and reads the first logical-to-physical address conversion table 233 stored in the first nonvolatile memory 23. Next, the first memory controller 22 reads the second logical-to-physical address conversion table 333 stored in the second nonvolatile memory 33. The first memory controller 22 starts the memory system 2 in the read&write mode for the first nonvolatile memory 23 and the second nonvolatile memory 33.

On the other hand, when the first memory controller 22 cannot detect the connection of the memory card 3 and determines that the memory card 3 is not present, the first memory controller 22 executes the initialization process and reads the first firmware 231 stored in the first nonvolatile memory 23. Next, the first memory controller 22 reads the first logical-to-physical address conversion table 233 stored in the first nonvolatile memory 23. The first memory controller 22 starts the memory system 2 in the read mode only for the first nonvolatile memory 23.

In addition, when the first memory controller 22 determines that the first identification ID 232 and the second identification ID 332 that are acquired do not match with each other, the first memory controller 22 executes the initialization process and reads the first firmware 231 stored in the first nonvolatile memory 23. Next, the first memory controller 22 reads the first logical-to-physical address conversion table 233 stored in the first nonvolatile memory 23. The first memory controller 22 starts the memory system 2 in the read mode only for the first nonvolatile memory 23.

That is, when the connection of the memory card 3 is detected and the first identification ID 232 and the second identification ID 332 match with each other, the memory system 2 starts in the read&write mode where data is read and written from and into the first nonvolatile memory 23 and the second nonvolatile memory 33. In addition, when the connection of the memory card 3 cannot be detected and the first identification ID 232 and the second identification ID 332 do not match with each other, the memory system 2 starts in the read mode where data is read only from the first nonvolatile memory 23.

Next, a data write process of the memory system 2 when the host device 1 transmits the write request to the memory system 2 started in the read&write mode will be described.

First, the first memory controller 22 receives the above-described write request from the host device 1. When the write request is received from the host device 1, the first memory controller 22 specifies a physical address corresponding to the logical address in the write request with reference to the first logical-to-physical address conversion table 233, and performs a write process of writing the received data into the first nonvolatile memory 23 and the second nonvolatile memory 33 in parallel based on the specified physical address. Next, the first memory controller 22 performs a read process of reading the written data from each of the first nonvolatile memory 23 and the second nonvolatile memory 33. Next, the first memory controller 22 determines whether a read error occurs in the data read from the first nonvolatile memory 23 and the second nonvolatile memory 33.

Here, when the first memory controller 22 determines that a read error does not occur in the data read from the first nonvolatile memory 23 and the second nonvolatile memory 33, the first memory controller 22 determines whether the read data match with each other. When the first memory controller 22 determines that the data read from the first nonvolatile memory 23 and the second nonvolatile memory 33 match with each other, the first memory controller 22 returns write normal end to the host device 1 and ends the data write process.

On the other hand, when the first memory controller 22 determines that a read error occurs in the data read from both of the first nonvolatile memory 23 and the second nonvolatile memory 33 or when the first memory controller 22 determines that the data read from the first nonvolatile memory 23 and the second nonvolatile memory 33 do not match with each other, the first memory controller 22 returns the error to the host device 1 and ends the data write process.

On the other hand, when the first memory controller 22 determines that a read error occurs in the data read from one of the first nonvolatile memory 23 or the second nonvolatile memory 33, the first memory controller 22 executes a write process (background process) of writing the data written in the second nonvolatile memory 33 into a physical address different from a physical address of the first nonvolatile memory 23 where the read error occurs, returns write normal end to the host device 1, and ends the data write process.

Here, since the background process requires a long period of time, the size of the second user data 334 to be written into the second nonvolatile memory 33 is divided, the second user data 334 is not written into the second nonvolatile memory 33 at once, and is dispersed little by little in parallel with a timing at which the process of writing the data from the first memory controller 22 into the first nonvolatile memory 23 is executed. The first memory controller 22 executes the background process such that a period of time in which a response to a command from the host device 1 is allowed is not exceeded.

Next, a data read process of the memory system 2 when the host device 1 transmits the read request to the memory system 2 started in the read&write mode will be described.

First, the first memory controller 22 receives a data read command from the host device 1. Next, the first memory controller 22 specifies a physical address corresponding to the logical address in the read request with reference to the first logical-to-physical address conversion table 233, and performs a read process of reading the data from the specified physical address. Next, the first memory controller 22 determines whether a read error occurs in the first user data 234 read from the first nonvolatile memory 23. The first memory controller 22 determines whether an error occurs in the read first user data 234, for example, using an error correction circuit (ECC circuit) mounted in the first memory controller 22.

Next, when the first memory controller 22 determines that a read error does not occur in the first user data 234 read from the first nonvolatile memory 23, the first memory controller 22 returns the first user data 234 read from the first nonvolatile memory 23 to the host device 1. The first memory controller 22 ends the data read process.

On the other hand, when the first memory controller 22 determines that a read error occurs in the first user data 234 read from the first nonvolatile memory 23, the read process of reading the second user data 334 stored in the second nonvolatile memory 33 will be described. For example, the first memory controller 22 specifies a physical address corresponding to the logical address in the read request with reference to the second logical-to-physical address conversion table 333, and reads the data from the specified physical address. Next, the first memory controller 22 determines whether a read error occurs in the second user data 334 read from the second nonvolatile memory 33.

Next, when the first memory controller 22 determines that a read error does not occur in the second user data 334 read from the second nonvolatile memory 33, the first memory controller 22 executes a write process (background process) of writing the data written in the second nonvolatile memory 33 into a physical address different from a physical address of the first nonvolatile memory 23 where the read error occurs. The first memory controller 22 returns the second user data 334 read from the second nonvolatile memory 33 to the host device 1. The first memory controller 22 ends the data read process.

On the other hand, when the first memory controller 22 determines that a read error occurs in the second user data 334 read from the second nonvolatile memory 33, the first memory controller 22 returns the error to the host device 1 and ends the data read process.

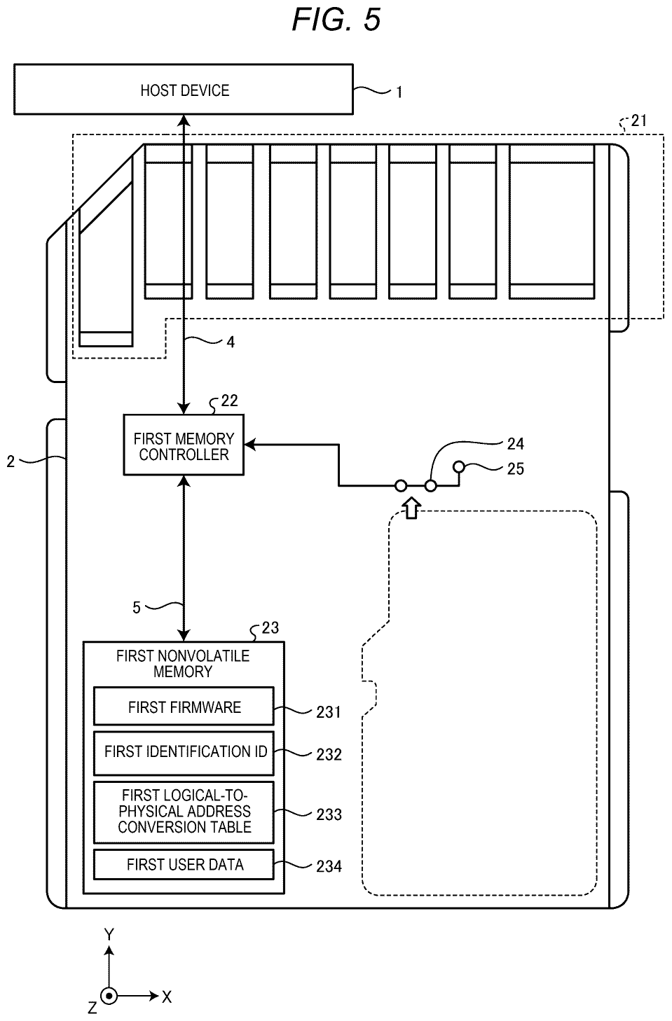

Next, a read process of the memory system 2 when the host device 1 transmits the read request to the memory system 2 started in the read mode will be described. FIG. 5 is a schematic diagram illustrating a schematic configuration of the memory system 2 according to the first embodiment. As illustrated in FIG. 5, the memory system 2 started in the read mode is in a state where the memory card 3 is not housed.

First, the first memory controller 22 executes the initialization process. Next, the first memory controller 22 reads the first firmware 231 stored in the first nonvolatile memory 23. Next, the first memory controller 22 reads the first logical-to-physical address conversion table 233 stored in the first nonvolatile memory 23.

The first memory controller 22 receives a request command from the host device 1 and determines a type of the request command. Here, when the first memory controller 22 determines that the request command received from the host device 1 is the data read command, the first memory controller 22 specifies a physical address corresponding to the logical address in the read request with reference to the first logical-to-physical address conversion table 233, and reads the data from the specified physical address. On the other hand, when the first memory controller 22 determines that the request command received from the host device 1 is the data write command, the first memory controller 22 returns the error to the host device 1.

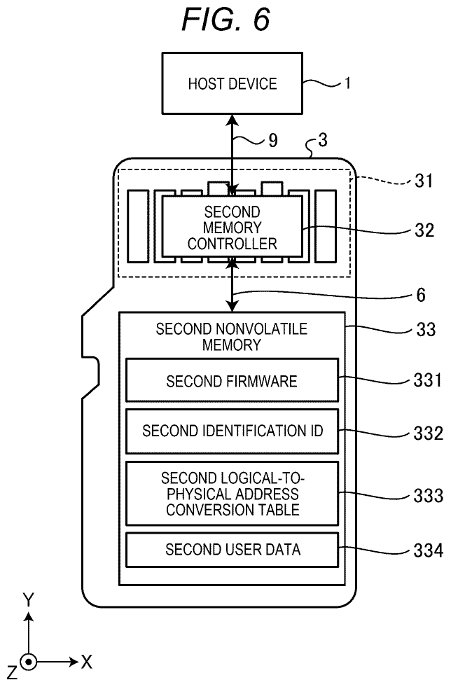

Next, when the host device 1 is connected to the memory card 3, a read process of the memory card 3 when the host device 1 transmits the read request to the memory card 3 will be described. FIG. 6 is a schematic diagram illustrating a schematic configuration of the host device 1 and the memory card 3 according to the first embodiment. The memory card 3 is connectable to the host device 1, and FIG. 6 illustrates a state where the memory card 3 is connected to the host device 1. The second memory controller 32 communicates with the host device 1, for example, through an SD interface 9.

First, the second memory controller 32 executes the initialization process. Next, the second memory controller 32 reads the second firmware 331 stored in the second nonvolatile memory 33. Next, the second memory controller 32 reads the second logical-to-physical address conversion table 333 stored in the second nonvolatile memory 33.

The second memory controller 32 receives a request command from the host device 1 and determines a type of the request command. Here, when the second memory controller 32 determines that the request command received from the host device 1 is the data write command, the second memory controller 32 returns the error to the host device 1.

On the other hand, when the second memory controller 32 determines that the request command received from the host device 1 is the read command of the second user data 334, the second memory controller 32 specifies a physical address corresponding to the logical address in the read request with reference to the second logical-to-physical address conversion table 333, and reads the data from the specified physical address.

For example, as illustrated in FIGS. 5 and 6, when the memory card 3 is taken out from the slot of the memory system 2, each of the memory system 2 and the memory card 3 operates in the read mode. Accordingly, the data is recorded in the two SD cards in parallel in response to the single write request from the host device 1, and for example, even when one of the SD cards is damaged, the data can be read from the remaining SD card.

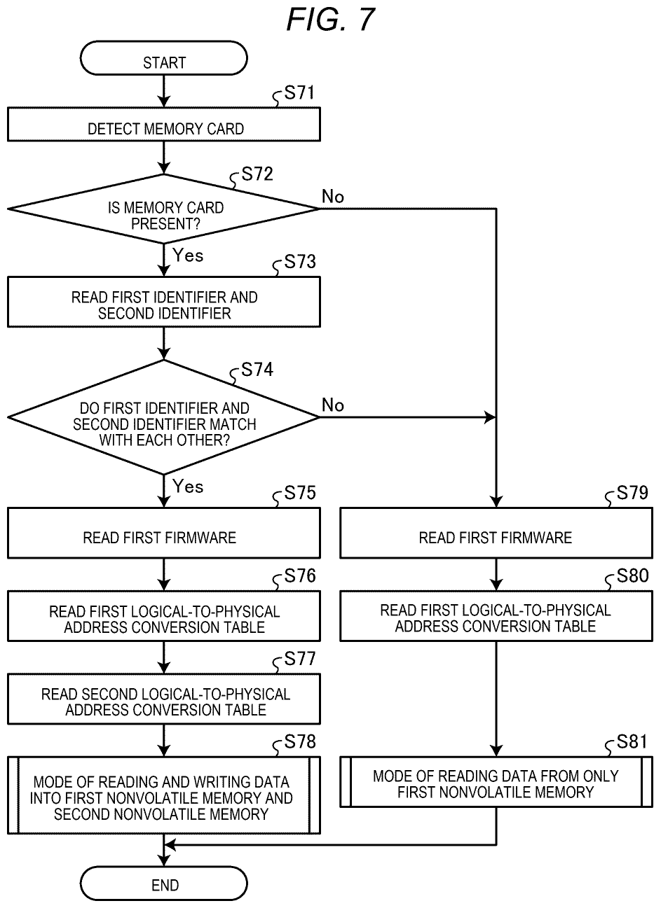

FIGS. 7 to 10 are flowcharts illustrating an operation of the memory system 2 according to the first embodiment. The flowchart illustrated in FIG. 7 illustrates the start process of the memory system 2. In the process in FIG. 7, the memory system 2 is recognized by the host device 1, and the first memory controller 22 starts after the power supply 25 of the first memory controller 22 enters into an ON state based on a power supplied from the host device 1 through the plurality of first terminals 21.

First, the first memory controller 22 detects the connection of the memory card 3 (Step S71). Next, the first memory controller 22 determines whether the memory card 3 is present (Step S72). Here, when the first memory controller 22 cannot detect the connection of the memory card 3 and determines that the memory card 3 is not present (Step S72: No), the process proceeds to Step S79. On the other hand, when the first memory controller 22 detects the connection of the memory card 3 and determines that the memory card 3 is present (Step S72: Yes), the process proceeds to Step S73.

In Step S73, the first memory controller 22 reads the first identification ID 232 stored in the first nonvolatile memory 23 and the second identification ID 332 stored in the second nonvolatile memory 33 (Step S73). Next, the first memory controller 22 determines whether the first identification ID 232 and the second identification ID 332 that are acquired match with each other (Step S74). Here, when the first memory controller 22 determines that the first identification ID 232 and the second identification ID 332 that are acquired do not match with each other (Step S74: No), the process proceeds to Step S79. On the other hand, when the first memory controller 22 determines whether the first identification ID 232 and the second identification ID 332 that are acquired match with each other (Step S74: Yes), the process proceeds to Step S75.

In Step S75, the first memory controller 22 executes the initialization process, and reads the first firmware 231 stored in the first nonvolatile memory 23 (Step S75). Next, the first memory controller 22 executes an initialization process and reads the first logical-to-physical address conversion table 233 stored in the first nonvolatile memory 23 (Step S76). Next, the first memory controller 22 reads the second logical-to-physical address conversion table 333 stored in the second nonvolatile memory 33 (Step S77). The first memory controller 22 starts the memory system 2 in the read&write mode for the first nonvolatile memory 23 and the second nonvolatile memory 33 (Step S78). As a result, the process for starting the memory system 2 ends.

In Step S79, the first memory controller 22 executes the initialization process, and reads the first firmware 231 stored in the first nonvolatile memory 23 (Step S79). Next, the first memory controller 22 reads the first logical-to-physical address conversion table 233 stored in the first nonvolatile memory 23 (Step S80). The first memory controller 22 starts the memory system 2 in the read mode only for the first nonvolatile memory 23 (Step S81). As a result, the process for starting the memory system 2 ends.

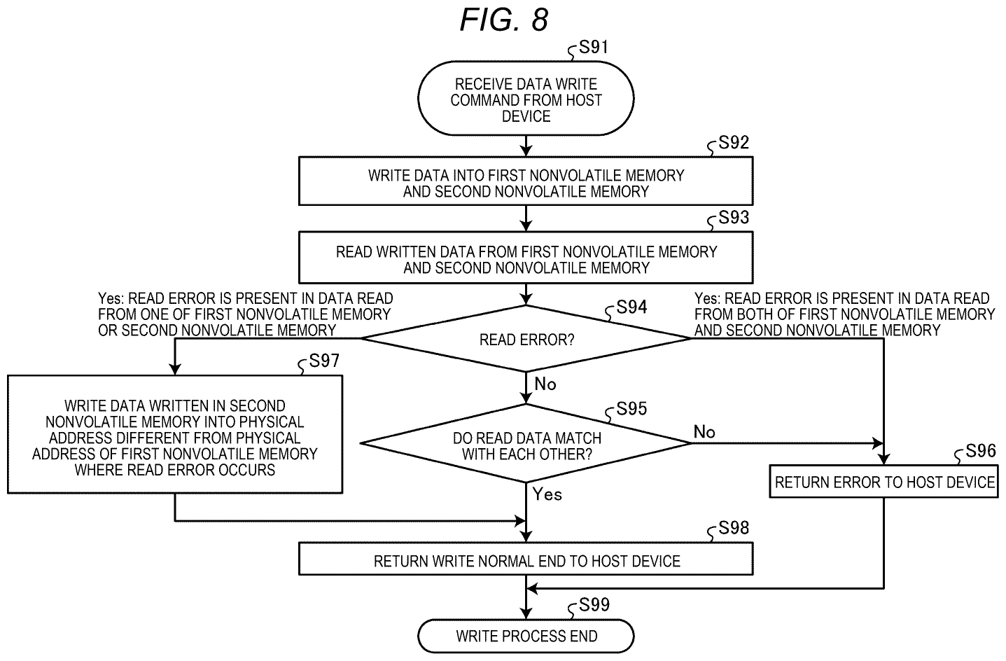

The flowchart illustrated in FIG. 8 illustrates the data write process of the memory system 2 when the host device 1 transmits the write request to the memory system 2 started in the read&write mode. The process of FIG. 8 starts in the state where the memory system 2 is in the read&write mode after executing the above-described process of Step S78 illustrated in FIG. 7.

First, the first memory controller 22 receives the data write command from the host device 1 (Step S91). Next, the first memory controller 22 specifies physical address corresponding to the logical address in the write request with reference to the first logical-to-physical address conversion table 233, and performs a write process of writing the received data into the first nonvolatile memory 23 and the second nonvolatile memory 33 in parallel based on the specified physical address (Step S92). Next, the first memory controller 22 performs a read process of reading the written data from each of the first nonvolatile memory 23 and the second nonvolatile memory 33 (Step S93).

Next, the first memory controller 22 determines whether a read error occurs in the data read from the first nonvolatile memory 23 and the second nonvolatile memory 33 (Step S94). Here, when the first memory controller 22 determines that a read error occurs in the data read from both of the first nonvolatile memory 23 and the second nonvolatile memory 33 (Step S94: Yes), the process proceeds to Step S96. On the other hand, when the first memory controller 22 determines that a read error occurs in the data read from one of the first nonvolatile memory 23 or the second nonvolatile memory 33 (Step S94: Yes), the process proceeds to Step S97.

On the other hand, when the first memory controller 22 determines whether a read error does not occur in the data read from the first nonvolatile memory 23 and the second nonvolatile memory 33 (Step S94: No), the process proceeds to Step S95. In Step S95, the first memory controller 22 determines whether the read data match with each other (Step S95). Here, when the first memory controller 22 determines that the data read from the first nonvolatile memory 23 and the second nonvolatile memory 33 match with each other (Step S95: Yes), the process proceeds to Step S98. On the other hand, when the first memory controller 22 determines that the data read from the first nonvolatile memory 23 and the second nonvolatile memory 33 do not match with each other (Step S95: No), the process proceeds to Step S96.

In Step S96, the first memory controller 22 returns the error to the host device 1 (Step S96). In Step S97, the first memory controller 22 performs a write process of writing the data written in the second nonvolatile memory 33 into a physical address different from a physical address of the first nonvolatile memory 23 where the read error occurs (Step S97). In Step S98, the first memory controller 22 returns write normal end to the host device 1 (Step S98). In Step S99, the first memory controller 22 ends the data write process.

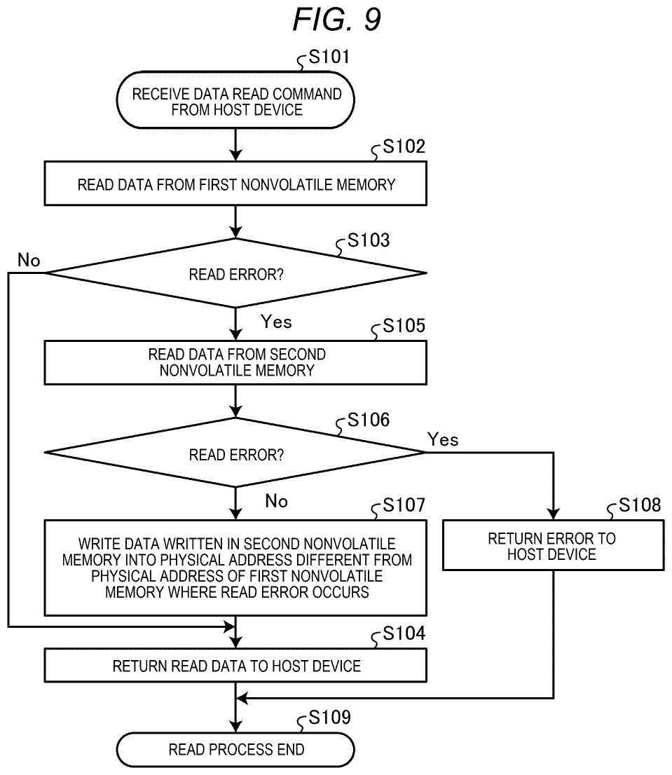

The flowchart illustrated in FIG. 9 illustrates the data read process of the memory system 2 when the host device 1 transmits the read request to the memory system 2 started in the read&write mode. The process of FIG. 9 starts in the state where the memory system 2 is in the read&write mode after executing the above-described process of Step S78 illustrated in FIG. 7.

First, the first memory controller 22 receives the data read command from the host device 1 (Step S101). The first memory controller 22 specifies a physical address corresponding to the logical address in the read request with reference to the first logical-to-physical address conversion table 233, and performs a read process of reading the data from the specified physical address (Step S102). Next, the first memory controller 22 determines whether a read error occurs in the first user data 234 read from the first nonvolatile memory 23 (Step S103).

Here, when the first memory controller 22 determines that a read error occurs in the first user data 234 read from the first nonvolatile memory 23 (Step S103: Yes), the process proceeds to Step S105. On the other hand, when the first memory controller 22 determines that a read error does not occur in the first user data 234 read from the first nonvolatile memory 23 (Step S103: No), the process proceeds to Step S104. In Step S104, the first memory controller 22 returns the first user data 234 read from the first nonvolatile memory 23 to the host device 1 (Step S104).

In Step S105, the first memory controller 22 performs a read process of reading the second user data 334 stored in the second nonvolatile memory 33. Next, the first memory controller 22 determines whether a read error occurs in the second user data 334 read from the second nonvolatile memory 33 (Step S106).

Here, when the first memory controller 22 determines that a read error occurs in the second user data 334 read from the second nonvolatile memory 33 (Step S106: Yes), the process proceeds to Step S108. On the other hand, when the first memory controller 22 determines that a read error does not occur in the second user data 334 read from the second nonvolatile memory 33 (Step S106: No), the process proceeds to Step S107.

In Step S107, the first memory controller 22 performs a write process of writing the data written in the second nonvolatile memory 33 into a physical address different from a physical address of the first nonvolatile memory 23 where the read error occurs (Step S107). In Step S108, the first memory controller 22 returns the error to the host device 1 (Step S108). In Step S109, the first memory controller 22 ends the data read process.

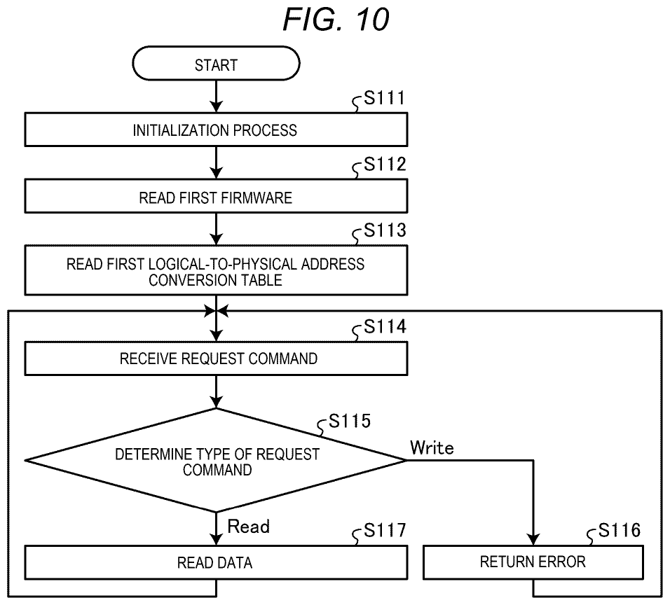

The flowchart illustrated in FIG. 10 illustrates the data read process of the memory system 2 when the host device 1 transmits the read request to the memory system 2 started in the read mode. The process of FIG. 10 starts in the state where the memory system 2 is in the read mode after executing the above-described process of Step S81 illustrated in FIG. 7. In addition, in the process of FIG. 10, as illustrated in FIG. 5, the memory system 2 started in the read mode is in a state where the memory card 3 is not housed.

First, the first memory controller 22 executes the initialization process (Step S111). Next, the first memory controller 22 reads the first firmware 231 stored in the first nonvolatile memory 23 (Step S112). Next, the first memory controller 22 reads the first logical-to-physical address conversion table 233 stored in the first nonvolatile memory 23 (Step S113).

Next, the first memory controller 22 receives the request command from the host device 1 (Step S114). Next, the first memory controller 22 determines a type of the request command received from the host device 1 (Step S115).

Here, when the first memory controller 22 determines that the request command received from the host device 1 is the data read command (Step S115: Read), the process proceeds to Step S117. On the other hand, when the first memory controller 22 determines that the request command received from the host device 1 is the data write command (Step S115: Write), the process proceeds to Step S116.

In Step S116, the first memory controller 22 returns the error to the host device 1 (Step S116). In Step S117, the first memory controller 22 specifies a physical address corresponding to the logical address in the read request with reference to the first logical-to-physical address conversion table 233, and reads the data from the specified physical address (Step S117). When the process of Step S116 or Step S117 ends, the first memory controller 22 proceeds to Step S114.

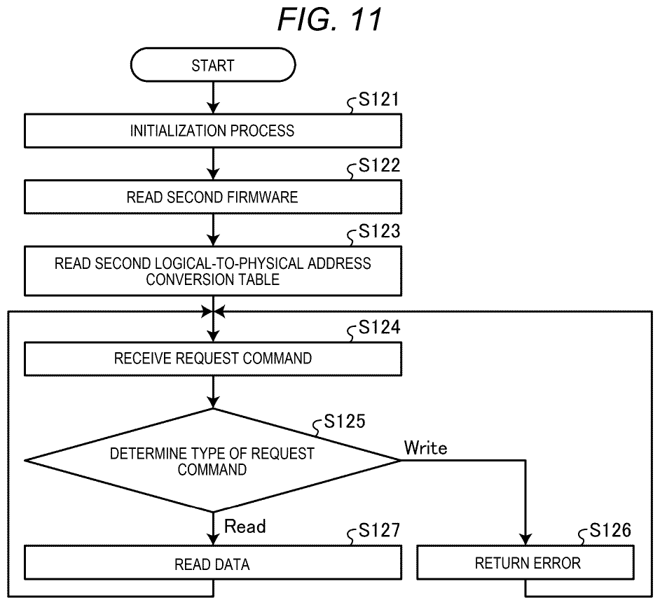

FIG. 11 is a flowchart illustrating an operation of the memory card 3 according to the first embodiment. The process in FIG. 11 is the process of the memory card 3 when the memory card 3 is connected to the host device 1 as illustrated in FIG. 6.

First, the second memory controller 32 executes the initialization process (Step S121). Next, the second memory controller 32 reads the second firmware 331 stored in the second nonvolatile memory 33 (Step S122). Next, the second memory controller 32 reads the second logical-to-physical address conversion table 333 stored in the second nonvolatile memory 33 (Step S123).

Next, the second memory controller 32 receives the request command from the host device 1 (Step S124). Next, the second memory controller 32 determines a type of the request command received from the host device 1 (Step S125).

Here, when the second memory controller 32 determines that the request command received from the host device 1 is the data read command (Step S125: Read), the process proceeds to Step S127. On the other hand, when the second memory controller 32 determines that the request command received from the host device 1 is the data write command (Step S125: Write), the process proceeds to Step S126.

In Step S126, the second memory controller 32 returns the error to the host device 1 (Step S126). In Step S127, the second memory controller 32 specifies a physical address corresponding to the logical address in the read request with reference to the second logical-to-physical address conversion table 333, and reads the data from the specified physical address (Step S127).

As described above, in the first embodiment, when the memory card 3 is connected to the memory system 2, the memory system 2 acquires an identification ID of the second nonvolatile memory 33 from the memory card 3, and in response to a write request from the host device 1, when the first identification ID 232 that is an identification ID of the first nonvolatile memory 23 and the second identification ID 332 that is the acquired identification ID of the second nonvolatile memory 33 match with each other, the memory system 2 writes data based on data designated by the write request into the first nonvolatile memory 23 and the second nonvolatile memory 33. That is, only when the association between the first nonvolatile memory 23 and the second nonvolatile memory 33 is authenticated, the first memory controller 22 writes data based on data designated by the write request from the host device 1 into the first nonvolatile memory 23 and the second nonvolatile memory 33.

As a result, for example, in a camera as the host device 1 on which a slot that can house one SD card is mounted, only when an identifier of a nonvolatile memory of the SD card (first SD card) housed in the slot of the camera and an identifier of a nonvolatile memory of an SD card (second SD card) housed in a slot provided in the first SD card match with each other, an image acquired by the camera is recorded in the respective nonvolatile memories of the first SD card and the second SD card in parallel.

For example, the user can record the image acquired by the camera in the different SD cards, and thus backup data can be generated. Accordingly, in the first embodiment, a memory card that can house another memory card is recognized as one memory card and can record an acquired image in two nonvolatile memories in parallel.

In addition, in the above-described first embodiment, when the second SD card is taken out from the slot of the first SD card, each of the first SD card and the second SD card operates in the read mode. Accordingly, a response from the host device side is not required, the data is recorded in the two SD cards in parallel in response to the single write operation, and for example, even when one of the SD cards is damaged, the data can be read from the remaining SD card.

### First Modification Example

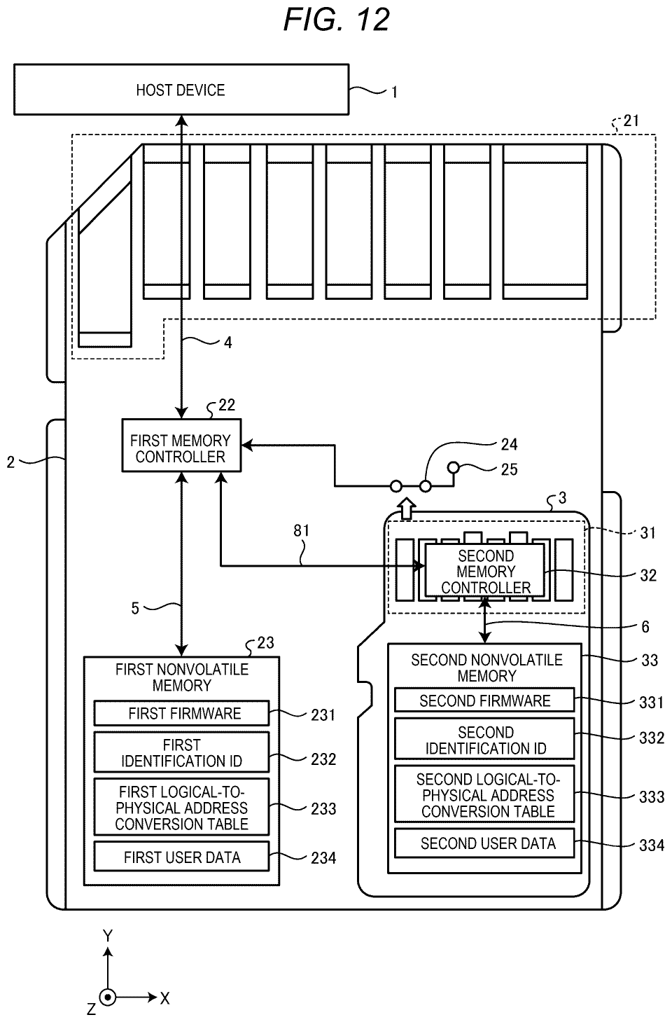

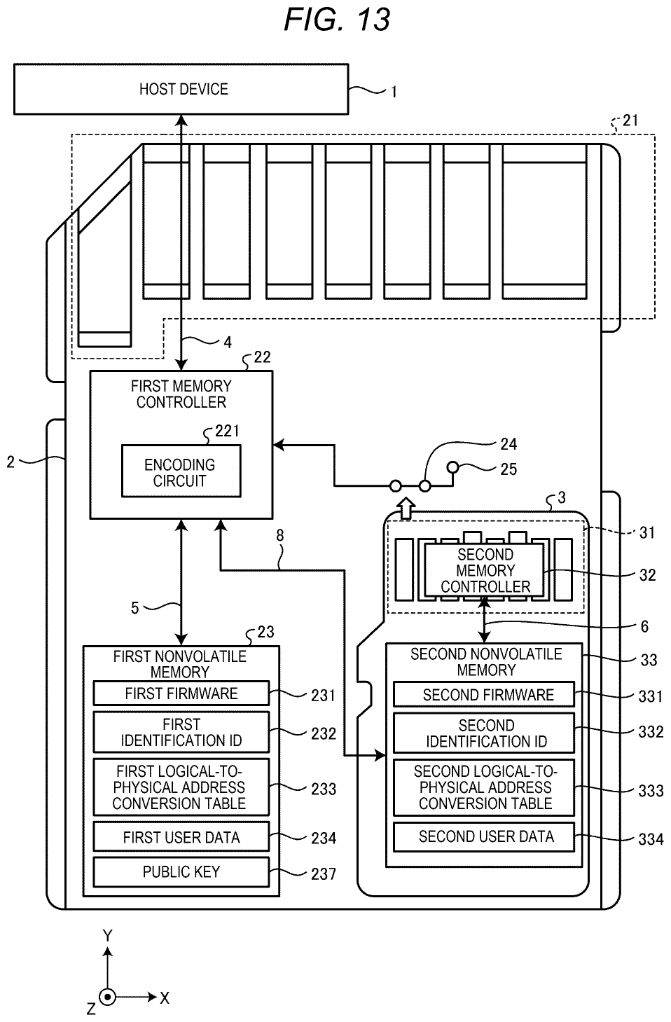

In the above-described first embodiment, as the aspect where the memory system 2 is connected to the memory card 3, the form of the connection through the NAND interface is described. However, the embodiment is not limited to this configuration. In a memory system 2 according to a first modification example, as the form where the memory system 2 is connected to the memory card 3, the form of the connection through an SD interface will be described using FIGS. 12 and 13. FIG. 12 is a schematic diagram illustrating the form where the memory system 2 according to the first modification example is connected to the memory card 3. The same components as those of the above-described embodiment are represented by the same reference numerals, and the detailed description thereof will not be repeated.

FIG. 12 is a schematic diagram illustrating a schematic configuration of the memory system 2 according to the first modification example. FIG. 12 is different from FIG. 1 in the form where the memory system 2 is connected to the memory card 3. FIG. 12 illustrates the form where the first memory controller 22 of the memory system 2 is connected to the second memory controller 32 of the memory card 3 through an SD interface 81.

For example, when a user houses the memory card 3 in the slot of the memory system 2, a terminal of the memory system 2 and a terminal of the memory card 3 are connected. Here, the terminal of the memory card 3 according to the first modification example is the SD interface 81, which is an example of the plurality of third terminals. When the connection of the memory card 3 is detected, the first memory controller 22 is connected to the second memory controller 32 through the SD interface 81.

When the memory card 3 is connected to the memory system 2, the first memory controller 22 acquires an identifier of the second nonvolatile memory 33 from the memory card 3, and in response to a write request from the host device 1, when the first identification ID 232 that is an identifier of the first nonvolatile memory 23 and the second identification ID 332 that is the acquired identifier of the second nonvolatile memory 33 match with each other, the first memory controller 22 writes data based on data designated by the write request into the second nonvolatile memory 33 through the plurality of third terminals.

### Second Embodiment

In a second embodiment, a form where the first memory controller 22 of the memory system 2 includes an encoding circuit, writes data designated by the write request from the host device 1 into the first nonvolatile memory 23, and performs a write process of writing the data encoded by the encoding circuit into the second nonvolatile memory 33 will be described. The same components as those of the above-described embodiment are represented by the same reference numerals, and the detailed description thereof will not be repeated.

FIG. 13 is a schematic diagram illustrating a schematic configuration of the memory system 2 according to the second embodiment. In the memory system 2 illustrated in FIG. 13, as compared to FIG. 1, the first memory controller 22 further includes an encoding circuit 221, the first nonvolatile memory 23 stores a public key 237. The encoding circuit 221 encodes the data using an encoding scheme. In addition, the encoding circuit 221 is implemented by hardware such as a logic circuit or software.

The public key 237 stored in the first nonvolatile memory 23 is stored in the first nonvolatile memory 23, for example, when the user performs a write process of writing the public key 237 from the host device 1 into the memory system 2 that houses the memory card 3. In addition, for example, a private key for decoding corresponding to the public key 237 is stored by the user.

Next, a data write process of the memory system 2 when the host device 1 transmits the write request to the memory system 2 started in the read&write mode will be described.

The first memory controller 22 according to the second embodiment receives the data write command from the host device 1. Next, the first memory controller 22 specifies a physical address corresponding to the logical address in the write request with reference to the first logical-to-physical address conversion table 233, and performs a write process of writing the received data into the first nonvolatile memory 23 based on the specified physical address.

The first memory controller 22 reads the public key 237 from the first nonvolatile memory 23, and causes the encoding circuit 221 to encode the data received by the first nonvolatile memory 23 using the read public key 237. The first memory controller 22 specifies a physical address corresponding to the logical address in the write request with reference to the second logical-to-physical address conversion table 333, and performs a write process of writing the second user data 334 encoded by the encoding circuit 221 into the second nonvolatile memory 33 based on the specified physical address.

Here, the first user data 234 that is not encoded is stored in the first nonvolatile memory 23. For example, when the host device 1 is a camera, the user may want to check image data acquired by the camera immediately. When the image data encoded by the encoding circuit 221 is stored in the first nonvolatile memory 23, the camera decodes the encoded image data using the private key, and outputs the decoded image data. Therefore, since the camera executes the decoding process, the period of time required for the output may increase. That is, the user may require a period of time to check the image data acquired by the camera. Therefore, the first memory controller 22 stores the first user data 234 that is not encoded by the encoding circuit 221 in the first nonvolatile memory 23.

Next, a data read process of the memory system 2 when the host device 1 transmits the read request to the memory system 2 started in the read&write mode will be described.

The first memory controller 22 according to the second embodiment specifies a physical address corresponding to the logical address in the read request with reference to the first logical-to-physical address conversion table 233, and performs a read process of reading the data from the specified physical address. Next, the first memory controller 22 determines whether a read error occurs in the first user data 234 read from the first nonvolatile memory 23.

Next, when the first memory controller 22 determines that a read error does not occur in the first user data 234 read from the first nonvolatile memory 23, the first memory controller 22 returns the first user data 234 read from the first nonvolatile memory 23 to the host device 1. The first memory controller 22 ends the data read process.

On the other hand, when the first memory controller 22 determines that a read error occurs in the first user data 234 read from the first nonvolatile memory 23, the first memory controller 22 returns the error to the host device 1 and ends the data read process.

Here, the reason why the first memory controller 22 does not read the second user data 334 that is encoded by the encoding circuit 221 stored in the second nonvolatile memory 33 is that the private key for decoding the encoded data in the first nonvolatile memory 23 is not stored.

Next, a read process of the memory system 2 when the host device 1 transmits the read request to the memory system 2 started in the read mode will be described. As illustrated in FIG. 5, the memory system 2 started in the read mode is in a state where the memory card 3 is not housed.

The first memory controller 22 according to the second embodiment executes the initialization process. Next, the first memory controller 22 reads the first firmware 231 stored in the first nonvolatile memory 23. Next, the first memory controller 22 reads the first logical-to-physical address conversion table 233 stored in the first nonvolatile memory 23.

The first memory controller 22 receives a request command from the host device 1 and determines a type of the request command. Here, when the first memory controller 22 determines that the request command received from the host device 1 is the data read command, the first memory controller 22 performs a read process of reading the data from the first nonvolatile memory 23. On the other hand, when the first memory controller 22 determines that the request command received from the host device 1 is the data write command, the first memory controller 22 returns the error to the host device 1.

Next, when the host device 1 is connected to the memory card 3, a read process of the memory card 3 when the read request is transmitted to the memory card 3 will be described.

First, the second memory controller 32 executes the initialization process. Next, the second memory controller 32 reads the second firmware 331 stored in the second nonvolatile memory 33. Next, the second memory controller 32 reads the second logical-to-physical address conversion table 333 stored in the second nonvolatile memory 33.

The second memory controller 32 receives a request command from the host device 1 and determines a type of the request command. Here, when the second memory controller 32 determines that the request command received from the host device 1 is the data write command, the second memory controller 32 returns the error to the host device 1.

On the other hand, when the second memory controller 32 determines that the request command received from the host device 1 is the read command of the second user data 334, the second memory controller 32 specifies a physical address corresponding to the logical address in the read request with reference to the second logical-to-physical address conversion table 333, reads the data encoded by the encoding circuit 221 from the specified physical address, and returns the read data encoded by the encoding circuit 221 to the host device 1.

Here, when a private key for decoding corresponding to the public key 237 is stored, the host device 1 decodes, using the private key, the data that is encoded by the encoding circuit 221 and is returned from the second memory controller 32. On the other hand, when the private key for decoding corresponding to the public key 237 is not stored, the host device 1 cannot decode the data that is encoded by the encoding circuit 221 and is returned from the second memory controller 32. That is, the host device 1 can read the encoded data from the second nonvolatile memory 33. However, since the read data is encoded, the encoded data cannot be decoded unless the host device 1 stores the private key.

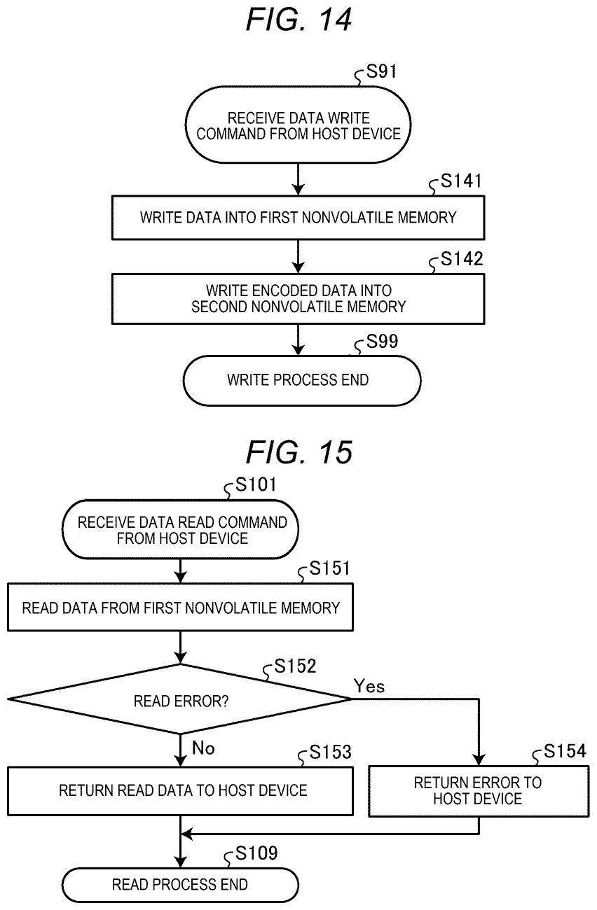

FIGS. 14 and 15 are flowcharts illustrating an operation of the memory system 2 according to the second embodiment. The flowchart illustrated in FIG. 14 illustrates the data write process of the memory system 2 when the host device 1 transmits the write request to the memory system 2 started in the read&write mode. The process of FIG. 14 starts in the state where the memory system 2 is in the read&write mode after executing the above-described process of Step S78 illustrated in FIG. 7. In addition, since the process of Step S91 and Step S99 illustrated in FIG. 14 are the same as that of Step S91 and Step S99 illustrated in FIG. 8, the description thereof will not be repeated.

In Step S141, the first memory controller 22 specifies a physical address corresponding to the logical address in the write request with reference to the first logical-to-physical address conversion table 233, and performs a write process of writing the received data into the first nonvolatile memory 23 based on the specified physical address (Step S141). In Step S142, the first memory controller 22 reads the public key 237 from the first nonvolatile memory 23, causes the encoding circuit 221 to encode the data received by the first nonvolatile memory 23 using the read public key 237, specifies a physical address corresponding to the logical address in the write request with reference to the second logical-to-physical address conversion table 333, and a write process of writing the second user data 334 encoded by the encoding circuit 221 into the second nonvolatile memory 33 based on the specified physical address (Step S142).

The flowchart illustrated in FIG. 15 illustrates the data read process of the memory system 2 when the host device 1 transmits the read request to the memory system 2 started in the read&write mode. The process of FIG. 15 starts in the state where the memory system 2 is in the read&write mode after executing the above-described process of Step S78 illustrated in FIG. 7. In addition, since the process of Step S101 and Step S109 illustrated in FIG. 15 are the same as that of Step S101 and Step S109 illustrated in FIG. 8, the description thereof will not be repeated.

In Step S151, the first memory controller 22 specifies a physical address corresponding to the logical address in the read request with reference to the first logical-to-physical address conversion table 233, and performs a read process of reading the data from the specified physical address (Step S151). In Step S152, the first memory controller 22 determines whether a read error occurs in the first user data 234 read from the first nonvolatile memory 23 (Step S152).

Here, when the first memory controller 22 determines that a read error occurs in the first user data 234 read from the first nonvolatile memory 23 (Step S152: Yes), the process proceeds to Step S154. On the other hand, when the first memory controller 22 determines that a read error does not occur in the first user data 234 read from the first nonvolatile memory 23 (Step S152: No), the process proceeds to Step S153.

In Step S153, the first memory controller 22 returns the data read from the first nonvolatile memory 23 to the host device 1 (Step S153). In Step S154, the first memory controller 22 returns the error to the host device 1 (Step S154).

As described above, in the second embodiment, the encoding circuit 221 is provided, when the memory card 3 is connected to the memory system 2, an identification ID of the second nonvolatile memory 33 is acquired from the memory card 3, and in response to a write request from the host device 1, when the first identification ID 232 that is an identifier of the first nonvolatile memory 23 and the second identification ID 332 that is the acquired identifier of the second nonvolatile memory 33 match with each other, data based on data designated by the write request from the host device 1 is written into the first nonvolatile memory 23, the encoding circuit 221 is caused to encode the data based on the data designated by the write request from the host device 1, and the encoded data is written into the second nonvolatile memory 33.

As a result, for example, in a camera as the host device 1 on which a slot that can house one SD card is mounted, only when an identifier of a nonvolatile memory of the SD card (first SD card) housed in the slot of the camera and an identifier of a nonvolatile memory of an SD card (second SD card) housed in a slot provided in the first SD card match with each other, an image acquired by the camera is written into the nonvolatile memory of the first SD card, the image encoded by the encoding circuit 221 is written into the nonvolatile memory of the second SD card, and the data can be recorded in the SD cards in parallel.

For example, the user can record the data obtained by encoding the image acquired by the camera and the data that is not encoded in the different SD cards, and thus backup data can be generated while improving security. Accordingly, in the second embodiment, a memory card that can house another memory card is recognized as one memory card and can record an acquired image in two nonvolatile memories in parallel.

### Second Modification Example

In a second modification example, the content of a process of the memory system 2 started in a different read mode from the above-described second embodiment will be described. As illustrated in FIG. 5, the memory system 2 started in the read mode according to the second modification example is in a state where the memory card 3 is not housed.

For example, in the memory system 2 according to the second modification example, in a case where the memory card 3 is not housed, when it is determined that the request command received from the host device 1 is the data read command, the error may be returned to the host device 1. This process can be used, for example, as a stricter method for data management when the memory card 3 is not housed in the memory system 2.

The first memory controller 22 according to the second modification example executes the initialization process. Next, the first memory controller 22 reads the first firmware 231 stored in the first nonvolatile memory 23. Next, the first memory controller 22 reads the first logical-to-physical address conversion table 233 stored in the first nonvolatile memory 23.

The first memory controller 22 receives a request command from the host device 1 and determines a type of the request command. Here, when the first memory controller 22 determines that the request command received from the host device 1 is the data read command, the first memory controller 22 returns the error to the host device 1. In addition, when the first memory controller 22 determines that the request command received from the host device 1 is the data write command, the first memory controller 22 returns the error to the host device 1.

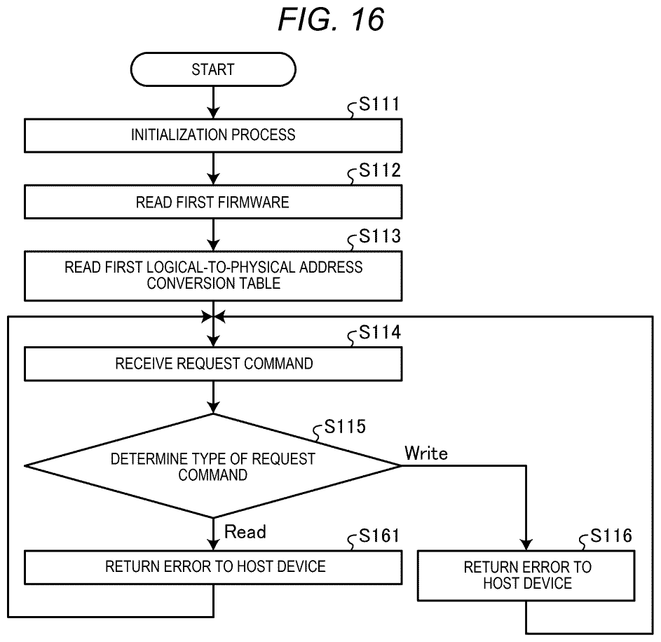

FIG. 16 is a flowchart illustrating an operation of the memory system 2 according to the second modification example. The flowchart illustrated in FIG. 16 illustrates the data read process of the memory system 2 when the host device 1 transmits the read request to the memory system 2 started in the read mode. The process of FIG. 16 starts in the state where the memory system 2 is in the read mode after executing the above-described process of Step S81 illustrated in FIG. 7.

In addition, in the process of FIG. 16, as illustrated in FIG. 5, the memory system 2 started in the read mode is in a state where the memory card 3 is not housed. Further, since the process of Step S111 to Step S116 illustrated in FIG. 16 are the same as that of Step S111 to Step S116 illustrated in FIG. 10, the description thereof will not be repeated.

In Step S161, the first memory controller 22 returns the error to the host device 1. As a result, in the second modification example, when the memory card 3 is not housed in the memory system 2, the data cannot be read. For example, the user can use the memory system 2, for example, as a stricter method for data management when the memory card 3 is not housed in the memory system 2.

### Third Modification Example

In the third modification example, the second nonvolatile memory 33 may include the public key 237. The same components as those of the above-described embodiment are represented by the same reference numerals, and the detailed description thereof will not be repeated.

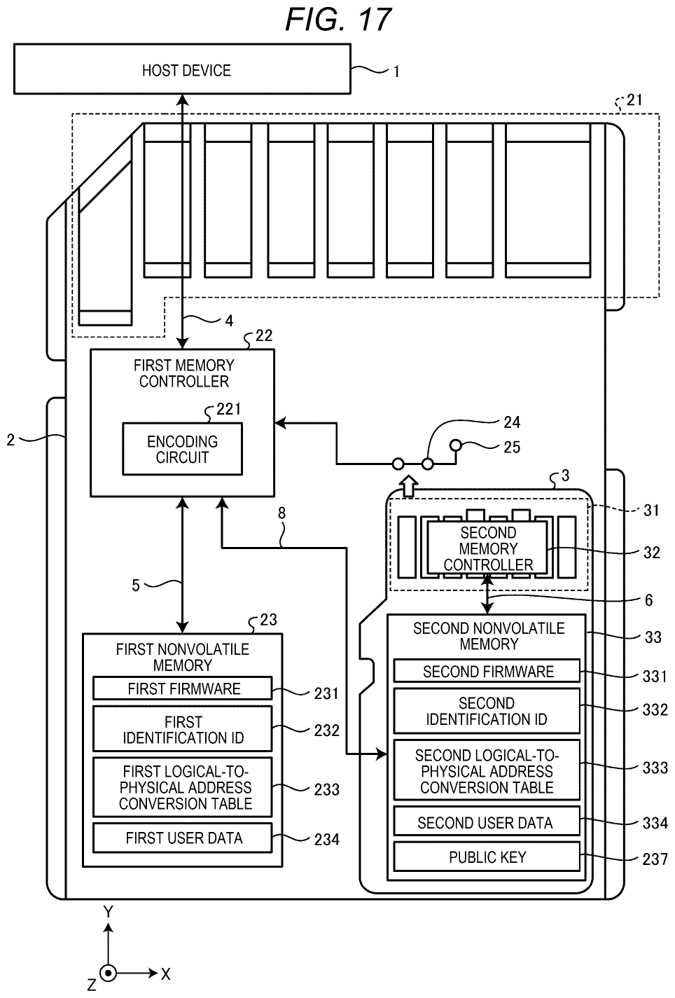

FIG. 17 is a schematic diagram illustrating a schematic configuration of the memory system 2 according to the third modification example. The memory system 2 illustrated in FIG. 17 is different from that of FIG. 14 in that the second nonvolatile memory 33 stores the public key 237.

The public key 237 stored in the second nonvolatile memory 33 is stored in the second nonvolatile memory 33, for example, when the user performs a write process of writing the public key 237 from the host device 1 into the memory system 2 that houses the memory card 3. In addition, for example, a private key for decoding corresponding to the public key 237 is stored by the user.

Since the data write process of the memory system 2 when the host device 1 transmits the write request to the memory system 2 started in the read&write mode and the data read process of the memory system 2 where the host device 1 transmits the read request have the same contents of the processes as the contents of the processes according to the second embodiment, the description will not be repeated.

In addition, since the read process of the memory system 2 when the host device 1 transmits the read request to the memory system 2 started in the read mode also has the same content as the content of the process according to the second embodiment, the description will not be repeated.

### Fourth Modification Example

In a fourth modification example, the memory card 3 may include an encoding circuit and the public key 237. The same components as those of the above-described embodiment are represented by the same reference numerals, and the detailed description thereof will not be repeated.

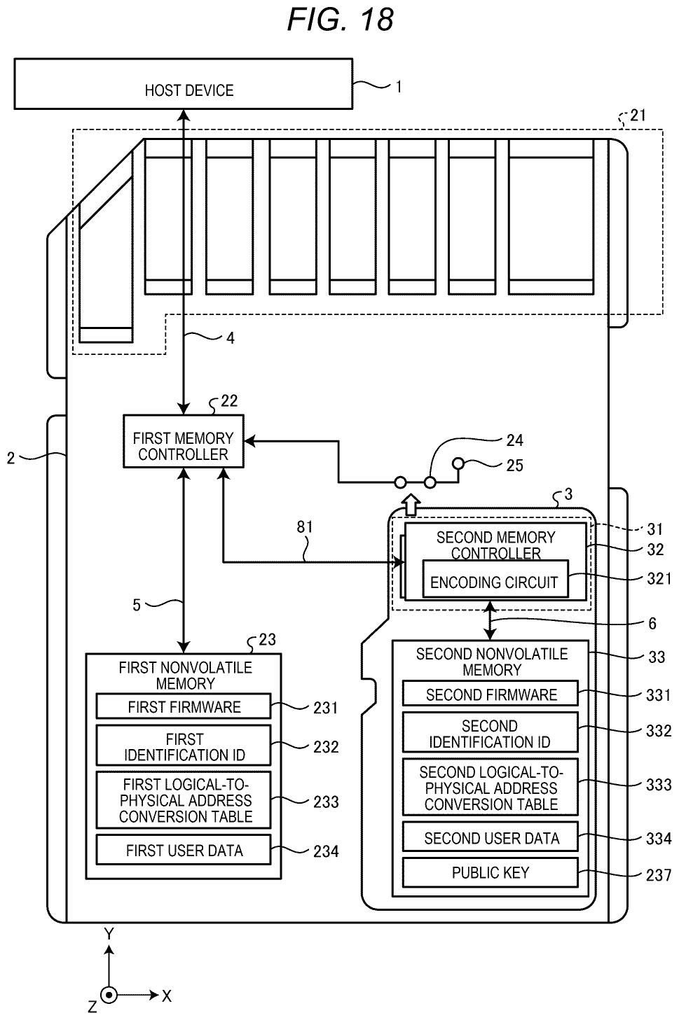

FIG. 18 is a schematic diagram illustrating a schematic configuration of the memory system 2 according to the fourth modification example. The memory system 2 illustrated in FIG. 18 is different from the memory system 2 illustrated in FIG. 13, in that the memory system 2 includes an encoding circuit 321 and the public key 237, and the memory card 3 includes the encoding circuit 321 and the public key 237.

The memory system 2 and the memory card 3 illustrated in FIG. 18 are different in that the second memory controller 32 of the memory card 3 includes the encoding circuit 321, the second nonvolatile memory 33 of the memory card 3 stores the public key 237, the memory card 3 is connected to the memory system 2 through an SD interface 81, and the first memory controller 22 instructs the second memory controller 32 to write the data into the second nonvolatile memory 33 through the SD interface 81.

When the data is written into the second nonvolatile memory 33, the second memory controller 32 causes the encoding circuit 321 to execute the encoding using an encryption key, and writes the encoded data into the second nonvolatile memory 33. The encoding circuit 321 encodes the data using an encoding scheme. In addition, the encoding circuit 321 is implemented by hardware such as a logic circuit or software.

The public key 237 stored in the second nonvolatile memory 33 is stored in the second nonvolatile memory 33, for example, when the user performs a write process of writing the public key 237 from the host device 1 into the memory system 2 that houses the memory card 3. In addition, for example, a private key for decoding corresponding to the public key 237 is stored by the user.

Next, a data write process of the memory system 2 when the host device 1 transmits the write request to the memory system 2 started in the read&write mode will be described.

The first memory controller 22 according to the fourth modification example receives the data write command from the host device 1. The first memory controller 22 specifies a physical address corresponding to the logical address in the write request with reference to the first logical-to-physical address conversion table 233, and performs a write process of writing data to be written based on the write command into the first nonvolatile memory 23 based on the specified physical address.

The second memory controller 32 reads the public key 237 from the second nonvolatile memory 33, and causes the encoding circuit 321 to encode the data to be written into the first nonvolatile memory 23 using the read public key 237. The first memory controller 22 specifies a physical address of the second nonvolatile memory 33 corresponding to the logical address designated by the write request with reference to the second logical-to-physical address conversion table 333, and performs a write process of writing the second user data 334 encoded by the encoding circuit 321 into the specified physical address.

In addition, since the read process of the memory system 2 when the host device 1 transmits the read request to the memory system 2 started in the read&write mode and the read mode also has the same content of the processes as the content of the process according to the second embodiment, the description will not be repeated.

### Fifth Modification Example

In a fifth modification example, a form where the memory system 2 sets a write-once area in the first nonvolatile memory 23 and the second nonvolatile memory 33 will be described. Specifically, in order to improve the integrity of the data, the memory system 2 sets a write-once area where the data can be written only once in the first nonvolatile memory 23 and the second nonvolatile memory 33, and writes the data into the first nonvolatile memory 23 and the second nonvolatile memory 33. In the memory system 2, when a logical address into which the data from the host device 1 is to be written is already written, the memory system 2 prevents the data based on data designated by the write request from being written into the first nonvolatile memory 23 and the second nonvolatile memory 33.

For example, the first memory controller 22 receives the data write command from the host device 1. Next, the first memory controller 22 specifies the logical address of the write command from the host device 1. Next, the first memory controller 22 determines whether the logical address into which the data is to be written from the host device 1 is rewriteable (a logical address into which no data is not written) or write-protected (a logical address in which data is already written).

The first nonvolatile memory 23 according to the fourth modification example stores the written logical address information in association with the first logical-to-physical address conversion table 233. The written logical address information includes information representing whether the logical address into which the data is to be written is already written or unused. For example, the first memory controller 22 determines whether the logical address into which the data is to be written from the host device 1 is rewriteable or write-protected with reference to the first logical-to-physical address conversion table 233 and the written logical address information.

Here, when the first memory controller 22 determines that the specified logical address is a rewriteable logical address, the first memory controller 22 converts the logical address into a physical address with reference to each of the logical-to-physical address conversion tables, performs a write process of writing the received data into the first nonvolatile memory 23 and the second nonvolatile memory 33, and ends the data write process.

On the other hand, when the first memory controller 22 determines that the specified logical address is already written and write-protected, the first memory controller 22 returns the error to the host device 1 and ends the data write process.

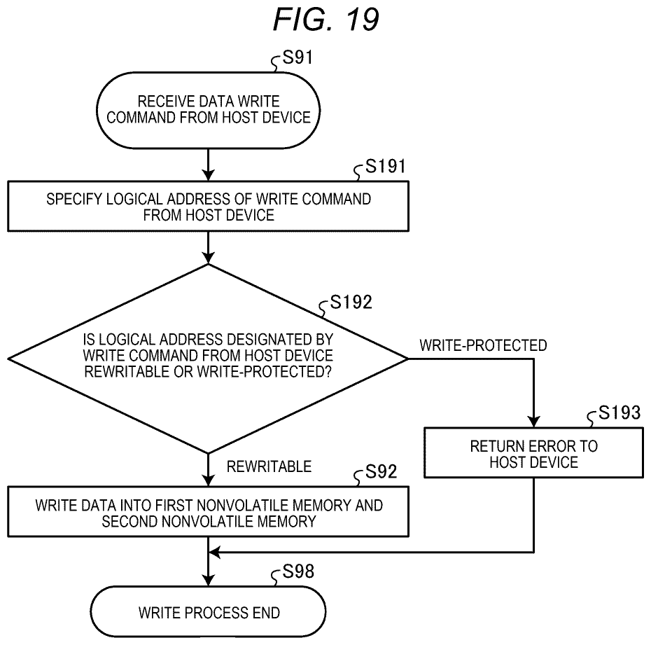

FIG. 19 is a flowchart illustrating an operation of the memory system 2 according to the fifth modification example. Since the process of Step S91 and Step S92 illustrated in FIG. 19 are the same as that of Step S91 and Step S92 illustrated in FIG. 8, the description thereof will not be repeated.

In Step S191, the first memory controller 22 specifies the logical address of the write command from the host device 1 (Step S191). In Step S192, the first memory controller 22 determines whether the logical address designated by the write command from the host device 1 is rewriteable or write-protected (Step S192).

Here, when the first memory controller 22 determines that the specified logical address is a rewriteable logical address (Step S192: Yes), the process proceeds to Step S92. On the other hand, when the first memory controller 22 determines that the specified logical address is already written and write-protected (Step S192: No), the process proceeds to Step S193. In Step S193, the first memory controller 22 returns the error to the host device 1 (Step S193).

As described above, in the fifth modification example, the write-once area where the data can be written only once is set in the first nonvolatile memory 23 and the second nonvolatile memory 33, and when a logical address into which the data from the host device 1 is to be written is already written, the data based on data designated by the write request is prevented from being written into the first nonvolatile memory 23 and the second nonvolatile memory 33. As a result, in the fifth modification example, the integrity of the data can be improved.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a first nonvolatile memory;
a first memory controller operatively coupled to the first nonvolatile memory through a first interface and to a host device; and
a connection portion to which a memory card is connectable, wherein the memory card includes a second nonvolatile memory and a second memory controller configured to control the second nonvolatile memory,
wherein when the memory card is connected to the memory system, the first memory controller is configured to acquire an identifier of the second nonvolatile memory from the memory card, and
in response to a write request from the host device, when an identifier of the first nonvolatile memory and the acquired identifier of the second nonvolatile memory match with each other, the first memory controller is configured to write data designated by the write request into the first nonvolatile memory and the second nonvolatile memory.

2. The memory system according to claim 1, further comprising a plurality of first terminals,
wherein the first memory controller is configured to communicate with the host device through the plurality of first terminals according to SD standards.

3. The memory system according to claim 1,
wherein the memory card includes a plurality of second terminals, and
the second memory controller is configured to communicate with the host device through the plurality of second terminals according to SD standards.

4. The memory system according to claim 1,
wherein the second nonvolatile memory includes a plurality of third terminals, and
the first memory controller is configured to write the data designated by the write request into the second nonvolatile memory through the plurality of third terminals.

5. The memory system according to claim 1,
wherein the first memory controller includes an encoding circuit, and
the first memory controller is configured to write the data designated by the write request into the first nonvolatile memory, cause the encoding circuit to encode the data designated by the write request, and write the encoded data into the second nonvolatile memory.

6. The memory system according to claim 5,
wherein the first nonvolatile memory is configured to store a public key for the encoding, and
the first memory controller is configured to read the public key from the first nonvolatile memory and cause the encoding circuit to execute the encoding using the read public key.

7. The memory system according to claim 1,
wherein in the first nonvolatile memory and the second nonvolatile memory, a write-once area where the data can be written only once is set, and
when a logical address into which the data from the host device is to be written is already written, the first memory controller is configured to prevent the data designated by the write request from being written into the first nonvolatile memory and the second nonvolatile memory.

8. The memory system according to claim 2,
wherein the memory system is an SD card, and
the memory card is an SD card having a different shape from the memory system.

9. The memory system according to claim 1,
wherein the identifier of the first nonvolatile memory is stored in the first nonvolatile memory, and
the first memory controller is configured to read the identifier of the first nonvolatile memory from the first nonvolatile memory to acquire the identifier of the first nonvolatile memory.

10. The memory system according to claim 1,
wherein the connection portion is a slot to house the memory card.

11. The memory system according to claim 10,
wherein the acquired identifier of the second nonvolatile memory is stored in the second nonvolatile memory, and
when the memory card is housed in the slot, the first memory controller is connected to the second nonvolatile memory through a second interface and configured to read the acquired identifier of the second nonvolatile memory from the second nonvolatile memory through the second interface.

12. The memory system according to claim 11,
wherein a read instruction of the acquired identifier of the second nonvolatile memory is received from the first memory controller through the second interface, and the second nonvolatile memory is configured to output the acquired identifier of the second nonvolatile memory to the first memory controller.

13. A control method, comprising:
acquiring, by a first memory controller from a memory card, an identifier of the memory card, when the memory card including a second nonvolatile memory and a second memory controller configured to control the second nonvolatile memory is connected, wherein the first memory controller is configured to control a first nonvolatile memory; and
in response to a write request from a host device, writing, by the first memory controller, data designated by the write request into the first nonvolatile memory and the second nonvolatile memory, when an identifier of a memory system and the acquired identifier of the second nonvolatile memory match with each other.

14. The control method according to claim 13, further comprising communicating with the host device through a plurality of first terminals of the memory system according to SD standards.

15. The control method according to claim 13, further comprising communicating with the host device through a plurality of second terminals of the memory card according to SD standards.

16. The control method according to claim 13, further comprising writing the data designated by the write request into the second nonvolatile memory through a plurality of third terminals of the second nonvolatile memory.
